(19) United States
(12) Patent Application Publication
(10) Pub. No.: US 2003/0132396 A1
(43) Pub. Date: Jul. 17, 2003

(54) Luminescent photoconductor cell

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/046,089

(22) Filed: Jan. 16, 2002

(51) Int. Cl. F21K 2/00

(52) U.S. Cl. 250/462.1

(57) ABSTRACT

A luminescent photoconductor cell integrally blended with light emitting materials or connected with a luminescent layer composed of a number of light emitting materials. The light emitting materials serve to absorb and reserve the energy of a light source. Thereafter, the light emitting materials are able to release the reserved energy by way of light. At night or in a dark place or when the light source disappears, the light emitting materials provide visible light to achieve luminescent effect.

### BACKGROUND OF THE INVENTION

The present invention is related to a luminescent photoconductor cell, and more particularly to a luminescent photoconductor cell which is able to conduct light to a liquid crystal module. Light emitting materials are connected with the photoconductor cell, whereby the photoconductor cell is able to absorb and reserve the light of external light source and back light source of the display. At night or in a dark place, when the back light source is not driven, the light emitting materials provide visible light to achieve luminescent effect.

The conventional back light type photoconductor cells 90 can be divided into direct lighting type, edge lighting type and hollow lighting type (as shown in FIGS. 11, 12 and 13 ). Such photoconductor cells 90 serve to provide even brightness for liquid crystal display. A user can thus clearly see the picture displayed on the display. The back light type photoconductor module generally employs LED or CCFL as light source 91. In the common electronic devices utilizing liquid crystal display, such as mobile phone, PDA, hand-held computer, etc., the light source 91 of LED or CCFL must provide sufficient luminance. The photoconductor module can thus create sufficient and even back light source. However, the power consumption of the battery is considerably great. In order to reduce the power consumption, the photoconductor picture and structural design of the back light module are improved to increase brightness and light emitting efficiency of the back light module and thus reduce the number of the light sources 91 and lower the power consumed by the light sources 91 and prolong using time of the battery. With PDA exemplified, in a dark place or at night, in order to maintain the seeable state of the displayed picture, all light sources 91 of the back light module must be full-time driven. Therefore, it will consume considerable power. When the light sources 91 disappear, the photoconductor cell 90 will lose its function of providing back light. As a result, no light beam penetrates through the display module 92 and no picture will be displayed.

### SUMMARY OF THE INVENTION

It is therefore a primary object of the present invention to provide a luminescent photoconductor cell connected with light emitting materials. The light emitting materials serve to absorb, reserve and release the energy of light. When the light source is turned to emit light, the light enters the photoconductor cell and conducted. At the same time, the light emitting materials start to absorb the light and release luminescence. When the light source disappears, the light emitting materials emit visible luminescence with original color so as to save energy.

The present invention can be best understood through the following description and accompanying drawings wherein:

### BRIEF DESCRIPTION OF THE DRAWINGS

FIG. 1 is a sectional view of a first embodiment of the present invention;

FIG. 2 is a sectional view showing the photoconduction of the edge lighting type photoconductor cell of the present invention;

FIG. 3 is a sectional view of a second embodiment of the present invention;

FIG. 4 is a sectional view of a third embodiment of the present invention;

FIG. 5 is a sectional view of a fourth embodiment of the present invention;

FIG. 6 is a sectional view of a fifth embodiment of the present invention;

FIG. 7 is a sectional view of a sixth embodiment of the present invention;

FIG. 8 is a sectional view of a seventh embodiment of the present invention;

FIG. 9 is a sectional view of an eighth embodiment of the present invention;

FIG. 10 is a sectional view of a ninth embodiment of the present invention;

FIG. 11 is a sectional view of a conventional back light type liquid crystal display;

FIG. 12 is a sectional view of another conventional back light type liquid crystal display; and

FIG. 13 is a sectional view of still another conventional back light type liquid crystal display.

### DETAILED DESCRIPTION OF THE PREFERRED EMBODIMENTS

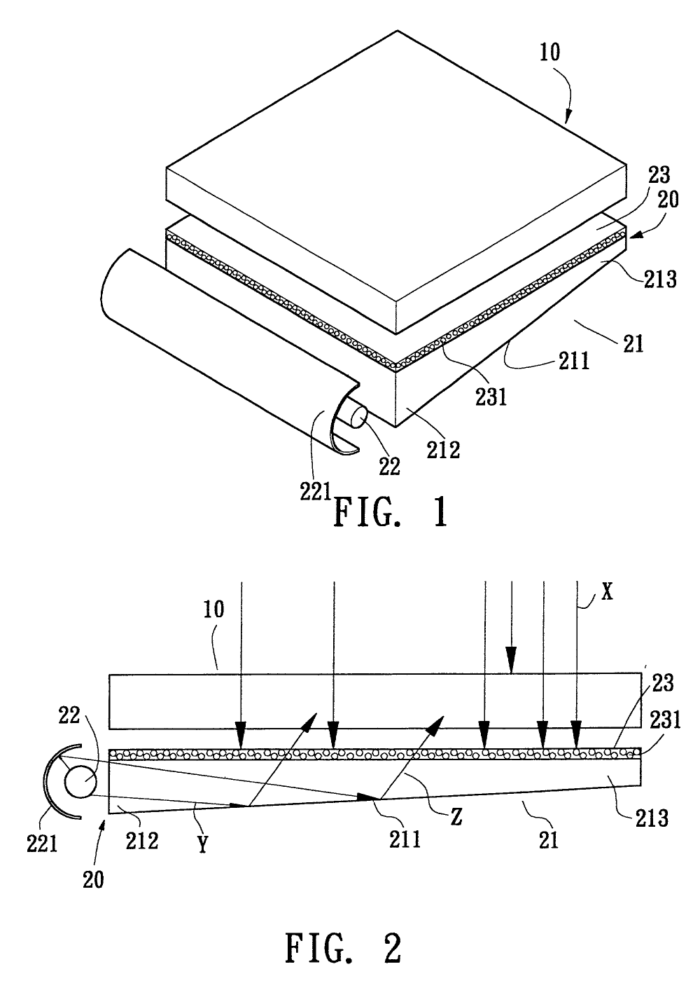

Please refer to FIG. 1. According to a first embodiment of the present invention, the photoconductor cell is an edge lighting type one.

The present invention is disposed in a liquid crystal display 1 having a liquid crystal module 10. A photoconductor module 20 is disposed on the bottom of the liquid crystal module 10. The photoconductor module 20 has a photoconductor cell 21. The bottom of the photoconductor cell 21 is formed with an inclined photoconduction face 211, whereby the thickness of the photoconductor cell 21 is tapered to form a thick end 212 and a thin end 213. One side of the thick end 212 of the photoconductor cell 21 distal from the thin end 213 is provided with a light source 22. A reflecting board 221 is disposed on one side of the light source 22 opposite to the photoconductor cell 21. In addition, a luminescent layer 23 composed of a number of light emitting materials 231 is connected with the light emitting face of the photoconductor cell 21. In this embodiment, the light emitting materials are powders. The luminescent layer 23 is positioned between the photoconductor cell 21 and the liquid crystal module 10.

It should be noted that the luminescent layer 23 on the photoconductor cell 21 is composed of a number of light emitting materials 231. The light emitting materials 231 are characterized in that they can absorb and reserve energy of light and release the energy by way of light. In prior art, in seeable state, the necessary light sources for the liquid crystal display include external light source of the liquid crystal display 1 (such as sunlight or fluorescent lamp ) and the light source 22 of the back light module 20. After the luminescent layer 23 absorbs the energy of the light, the luminescent layer 23 will reserve the energy and slowly release the absorbed and reserved energy by way of optical energy to form another seeable light beam. When the liquid crystal display 1 loses the light of the light source 22 and the external light source, the seeable light beam provides back light illumination for the liquid crystal display 1.

According to the lighting type, the light emitting materials of the present invention can be divided into self-lighting type and light-reserving type. According to variety of the materials, the light emitting materials can be divided into inorganic and organic materials. The self-lighting materials generally are radiant materials. Such radiant materials are strictly legally restricted in use, production and waste treatment. Therefore, they are rarely actually used. With respect to light-reserving materials, they are different in properties, light absorption speed, light-reserving ability, lighting ability, decay speed, etc. On market, the most popularly used materials are inorganic light-reserving material. For example, there is a generally seen inorganic light-reserving material has a main component of ZnS blended with specific activated component such as Cu. The original color of the main body of the material is yellow green. The energized wavelength is 200˜450 nm. The lighting wavelength is 530 nm. The brightness is 20˜30 mcd/m². The decay time is about 200 minutes. In addition, another new high efficiency inorganic light-reserving material with long lighting time has an energized wavelength of 200˜450 nm. The lighting wavelength is 520 nm. The brightness is 300 mcd/m². The decay time is over 2000 minutes. According to the above, the light emitting material of the present invention can truly generate visible light beam and maintain the light beam for a certain period of time. Therefore, the present invention is able to save energy.

Referring to FIG. 2, the luminescent photoconductor cell of the present invention can be mounted in the liquid crystal display 1 of a mobile phone or a PDA. The external light beam X penetrates through the liquid crystal module 10 to reach the luminescent layer 23 and be absorbed and reserved by the light emitting materials 231. When turning on the light source 22, the light beam Y generated by the light source 22 directly or via the reflecting board 221 gets into the photoconductor cell 21. The light beam Y entering the photoconductor cell 21 will penetrate there through to directly reach the luminescent layer 23. Also, the light beam Y can be reflected by the photoconduction face 211 to form a reflected light beam Z which penetrates through the photoconductor cell 21 to reach the luminescent layer 23. A part of the light beam reaching the luminescent layer 23 will be absorbed and reserved by the light emitting materials 231 thereof. A part of the light beam will penetrate through the luminescent layer 23. The light beam penetrating through the luminescent layer 23 and the light beam released by the light emitting materials 231 after absorbed and reserved will get into the liquid crystal module 10. The light beam is provided for the driving liquid crystal molecules (not shown ) arranged on the liquid crystal module 10. Therefore, the displayed picture of the liquid crystal display 1 can be seen from outer side.

When the light emitting materials 231 of the luminescent layer 23 absorbs the energy of the external light beam X and the reflected light beam Z, the light emitting materials 231 starts to reserve energy and release the energy by way of light. After a period of time, when one of or both of the external light beam X and the internal light beam Y disappear, the energy absorbed by the light emitting materials 231 of the luminescent layer 23 can be released for a period of time by way of light to provide visible (luminescent) light. Accordingly, it is unnecessary to full-time drive the light source 22 so as to save power of the battery (not shown ).

In conclusion, the light emitting materials 231 of the luminescent layer 23 are used to absorb, reserve, release and reuse the optical energy of the external light beam X and internal light beam Y Accordingly, in the case that the liquid crystal display 1 is placed in a dark place and the power source 22 is not full-time driven, the energy reserved by the light emitting materials 231 of the luminescent layer 23 can be released by way of light so as to provide visible (luminescent ) light. Therefore, the power can be saved and the light beam can be conducted to the luminescent photoconductor cell of the liquid crystal module 10.

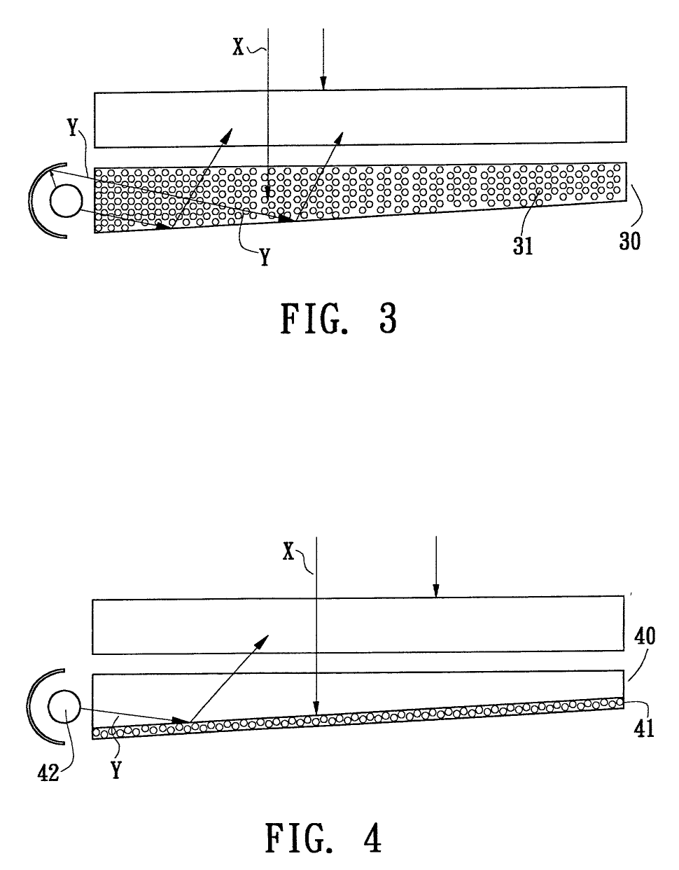

The above embodiment is only used to illustrate the present invention, not intended to limit the scope thereof. Many modifications of the above embodiment can be made without departing from the spirit of the present invention. For example, FIG. 3 shows a second embodiment of the present invention, in which the light emitting materials 31 are directly disposed in the photoconductor cell 30 which also serves as the luminescent layer. The light emitting materials 31 can continuously absorb the external light beam X and internal light beam Y and reserve energy. In a dark place or at night, the light emitting materials 31 in the photoconductor cell 30 can continuously release the energy to provide visible light beam so as to save power.

FIG. 4 shows a third embodiment of the present invention, in which the light emitting materials 41 are directly disposed on the back side of the photoconductor cell 40. The light emitting materials in the luminescent layer 41 can continuously absorb the external light beam X and internal light beam Y of the light source 42 and reserve energy. In a dark place or at night, the light emitting materials in the luminescent layer 41 can continuously release the energy to provide visible light beam so as to save power.

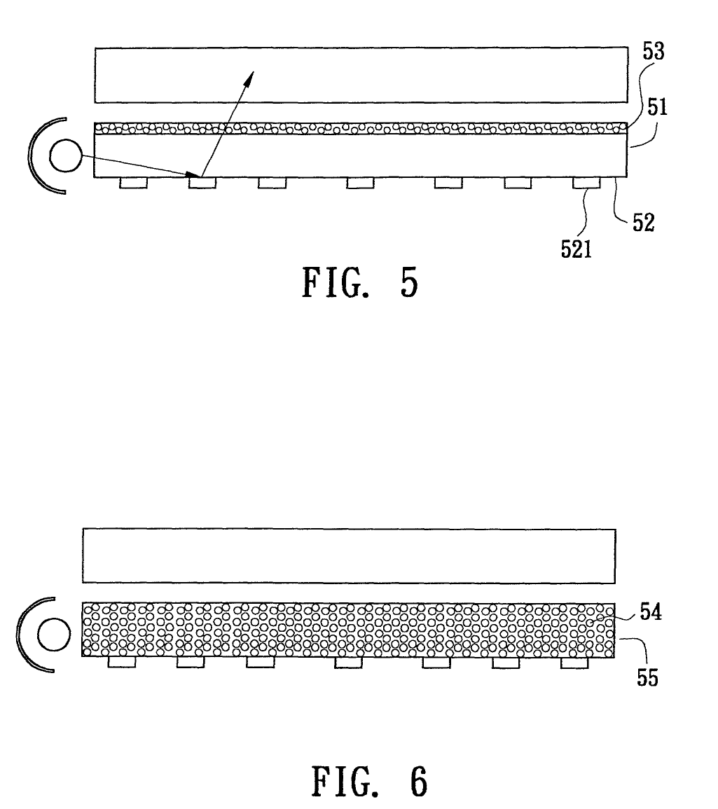

FIGS. 5, 6 and 7 show other embodiments of the present invention, in which the photoconduction face 52 of the bottom of the photoconductor cell 51 is a straight plane face. The photoconductor face 52 has multiple downward projecting photoconductor bosses 521. FIG. 5 shows a fourth embodiment of the present invention, in which the luminescent layer 53 is disposed on front side of the photoconductor cell 51. The light emitting materials in the luminescent layer 53 can continuously absorb the sunlight or the light of a lamp and reserve energy. In a dark place or at night, the light emitting materials in the luminescent layer 53 can continuously release the energy to provide visible light beam so as to save power.

FIG. 6 shows a fifth embodiment of the present invention, in which the light emitting materials 54 are directly disposed in the photoconductor cell 55. The light emitting materials 54 can continuously absorb the external light beam and internal light beam generated by the light source and reserve energy. In a dark place or at night, the light emitting materials in the photoconductor cell 55 can continuously release the energy to provide visible light beam so as to save power.

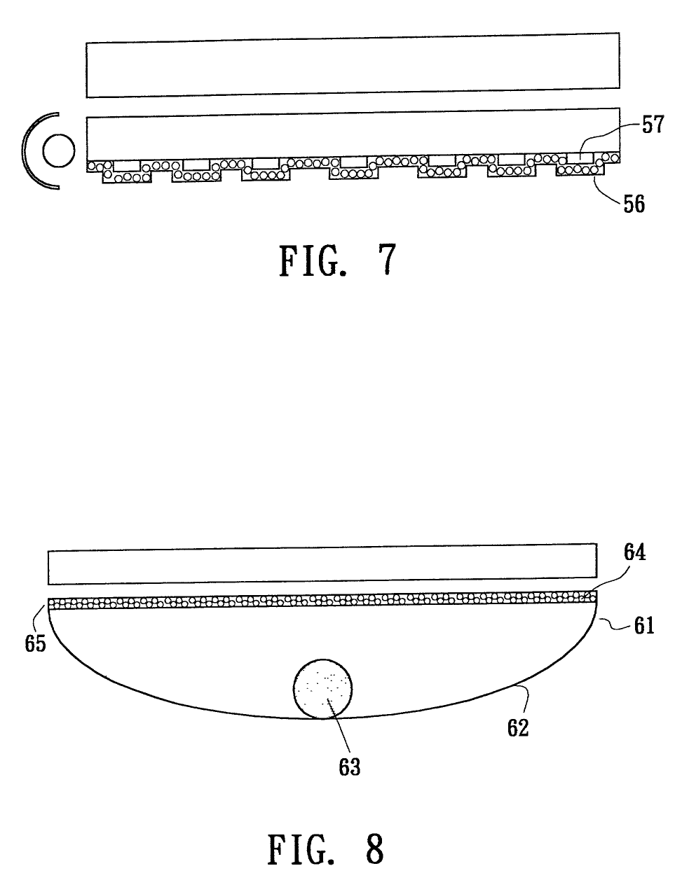

FIG. 7 shows a sixth embodiment of the present invention, in which the luminescent layer 56 composed of a number of luminescent powders is directly disposed on the bottoms the photoconductor bosses 57. The light emitting materials in the luminescent layer 56 can continuously absorb sunlight or the light of a lamp and reserve energy. In a dark place or at night, the light emitting materials in the luminescent layer 56 can continuously release the energy to provide visible light beam so as to save power.

FIGS. 8, 9 and 10 show other embodiments of the present invention, in which the photoconduction face 62 of the bottom of the photoconductor cell 61 is an arched face. The light source 63 is disposed in the photoconductor cell 61. FIG. 8 shows a seventh embodiment of the present invention, in which the luminescent layer 65 composed of a number of light emitting materials 64 is connected with the top of the light emitting face of the photoconductor cell 61. The light emitting materials in the luminescent layer 65 can continuously absorb the external light beam and internal light beam generated by the light source 63 and reserve energy. When losing light, the light emitting materials 64 in the luminescent layer 65 can continuously release the energy to provide visible light beam.

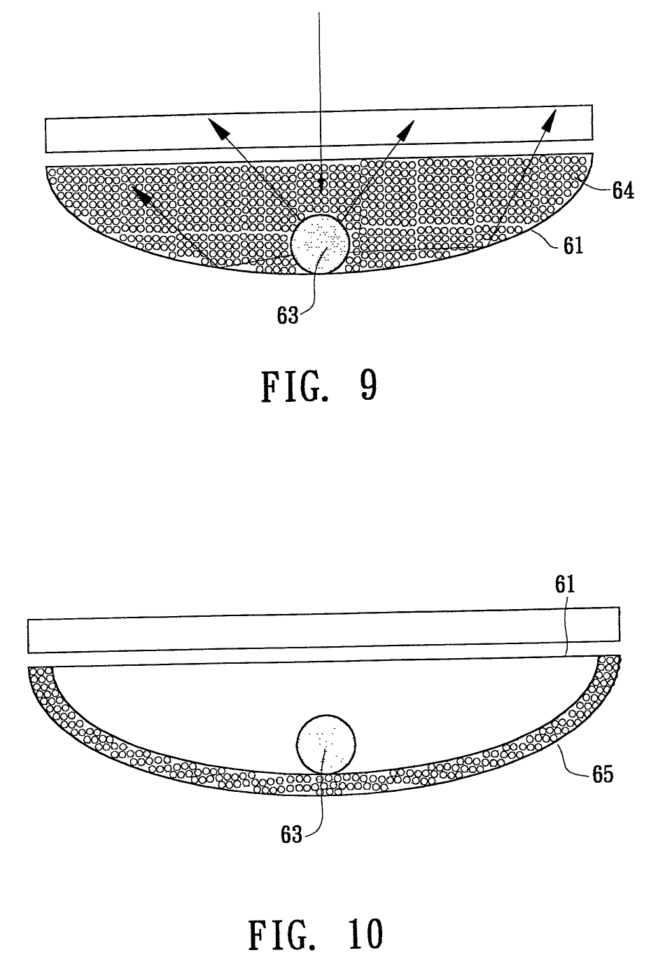

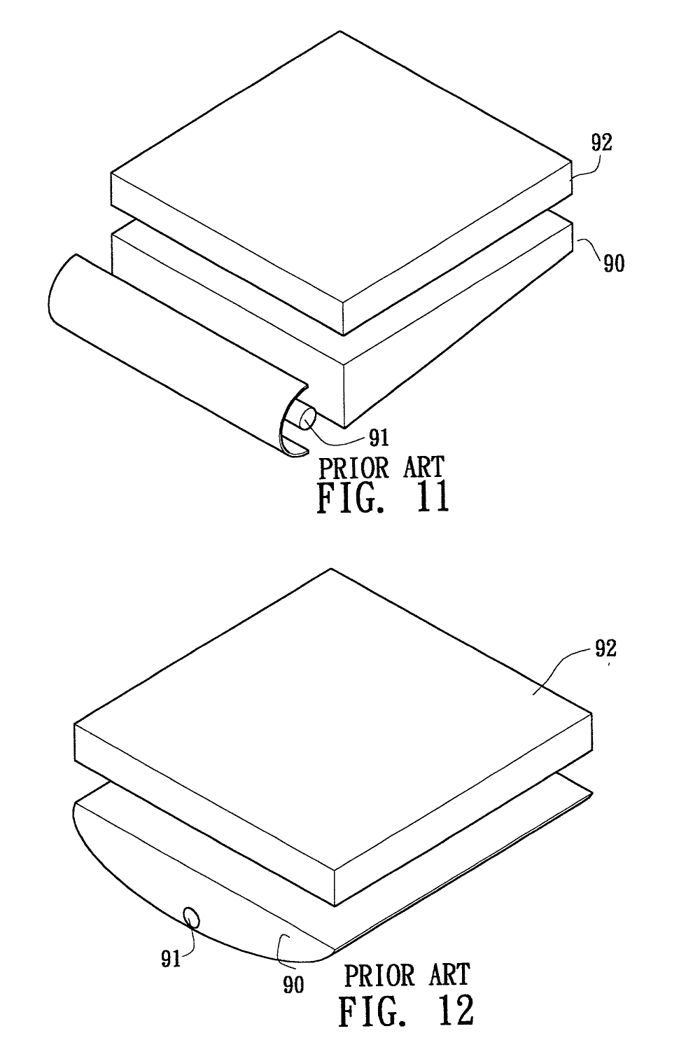

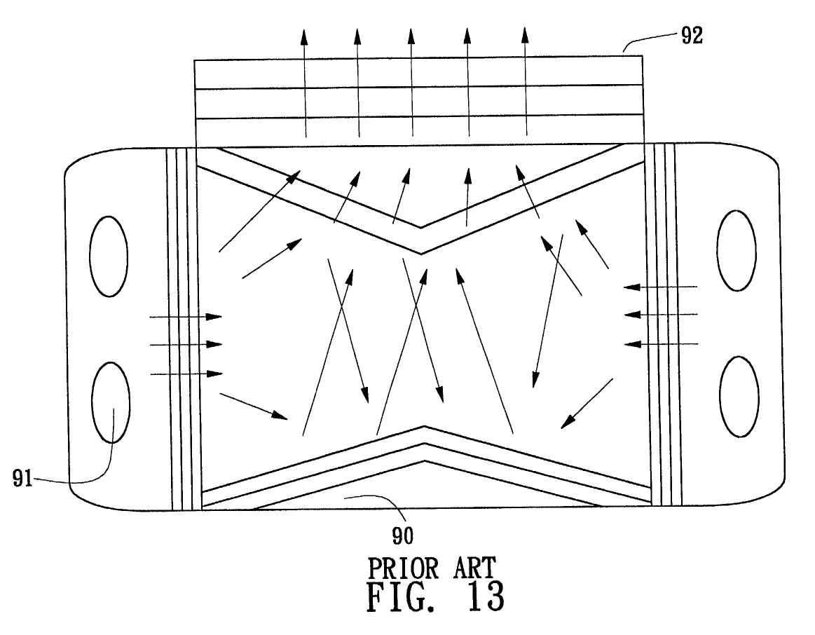

FIG. 9 shows an eighth embodiment of the present invention, in which the light emitting materials 64 are directly disposed in the photoconductor cell 61. The light emitting materials 64 can continuously absorb the external light beam and internal light beam generated by the light source 63 and reserve energy. In a dark place or at night, the light emitting materials 64 can continuously release the energy to provide visible light beam so as to save power.

FIG. 10 shows a ninth embodiment of the present invention, in which the luminescent layer 65 composed of a number of light emitting materials is disposed on the bottom of the photoconductor cell 61. The light emitting materials in the luminescent layer 65 can continuously absorb the external light beam and internal light beam generated by the light source 63 and reserve energy. In a dark place or at night, the light emitting materials in the luminescent layer 65 can continuously release the energy to provide visible light beam so as to save energy.

The present invention changes the photoconduction picture design and enhances photoconduction effect. In addition, the light emitting materials are disposed in the photoconductor cell or the luminescent layer composed of the light emitting materials is disposed on the top or bottom of the photoconductor cell to absorb, reserve and release energy. When the light source lights, the light beam enters the photoconductor cell for photoconduction and the luminescent layer starts to absorb the light and release luminescence. When the light source disappears, the luminescent layer emits visible light (luminescence ) with the original color. Accordingly, the photoconductor cell can continuously emit luminescence to save energy and meet the requirement of environmental protection. Also, the present invention helps in achieving evenness of photoconduction.

In a dark place or in a power cut state, the present invention can continuously release the energy to provide visible light beam. The light emitting materials can be blended with other luminescent colors or other luminescent colors can be mixed with the photoconductor cell to form various luminescent photoconductor cells with different colors.

What is claimed is:

1. A luminescent photoconductor cell disposed in a liquid crystal display having a liquid crystal module, a photoconductor module being disposed on the bottom of the liquid crystal module, the photoconductor module having a photoconductor cell, a bottom of the photoconductor cell being formed with a photoconduction face, a light source being disposed on the photoconductor module, a number of light emitting materials being connected with the photoconductor cell, the light emitting materials serving to absorb and reserve energy and release the reserved energy by way of light.

2. The luminescent photoconductor cell as claimed in claim 1, wherein the light emitting materials are combined to form an luminescent layer which is directly disposed on the photoconductor cell between the photoconductor cell and the liquid crystal module.

3. The luminescent photoconductor cell as claimed in claim 1, wherein the light emitting materials are directly mixed with the photoconductor cell.

4. The luminescent photoconductor cell as claimed in claim 1, wherein the light emitting materials are combined to form an luminescent layer which is directly disposed on the bottom of the photoconductor cell.

5. The luminescent photoconductor cell as claimed in claim 1, wherein the photoconduction face of the bottom of the photoconductor cell is a straight plane face having multiple dented and embossed photoconduction picture.

6. The luminescent photoconductor cell as claimed in claim 1, wherein the light emitting face of the upper side of the photoconductor cell is a straight plane face having multiple dented and embossed photoconduction picture.

7. The luminescent photoconductor cell as claimed in claim 1, wherein the photoconduction face of the photoconductor cell is an inclined face, whereby the thickness of the photoconductor cell is tapered to form a thick end and a thin end, one side of the thick end of the photoconductor cell distal from the thin end being provided with a light source, a reflecting board being disposed on one side of the light source opposite to the photoconductor cell.

8. The luminescent photoconductor cell as claimed in claim 1, wherein the photoconduction face of the bottom of the photoconductor cell is an arched face and the light source is disposed in the photoconductor cell.

9. The luminescent photoconductor cell as claimed in claim 1, wherein luminescent colors are blended with the light emitting materials.

10. The luminescent photoconductor cell as claimed in claim 1, wherein luminescent colors are blended with the photoconductor cell.
